(19) United States
(12) Patent Application Publication
(10) Pub. No.: US 2023/0235633 A1
(43) Pub. Date: Jul. 27, 2023

(54) LOST CIRCULATION FLUIDS AND METHODS RELATED THERETO

(71) Applicant: ExxonMobil Technology and Engineering Company, Spring, TX (US)

(72) Inventors: Robert M. SHIRLEY, The Woodlands, TX (US); P. Matthew SPIECKER, Manvel, TX (US)

(21) Appl. No.: 18/152,612

(22) Filed: Jan. 10, 2023

Related U.S. Application Data
(60) Provisional application No. 63/267,000, filed on Jan. 21, 2022.

(51) Int. Cl. E21B 21/00; E21B 33/13

(52) U.S. Cl. CPC E21B 21/003; E21B 33/13

(57) ABSTRACT

Lost circulation particles are commonly used in drilling and/or cementing operations to prevent fluid loss to a subterranean formation. Lost circulation fluids and methods of drilling and/or cementing operations may also use petroleum coke lost circulation particles composed of fluid coke and/or flexicoke material. Such petroleum coke lost circulation particles may have improved transport into wellbores because of their lower density compared to traditional lost circulation material and may produce fewer fines that can interfere with lost circulation efficacy.

### CROSS-REFERENCE TO RELATED APPLICATION

This application claims the benefit of U.S. Provisional Application Ser. No. 63/267,000, entitled “Lost Circulation Fluids and Methods Related Thereto,” filed Jan. 21, 2022, the disclosure of which is hereby incorporated by reference in its entirety.

### FIELD OF INVENTION

This application relates to wellbore drilling and/or cementing operations, and, in particular, to lost circulation material formed from petroleum coke, and methods related thereto.

### BACKGROUND OF THE INVENTION

In the oil and gas industry, hydrocarbons can be produced from subterranean formations penetrated by a wellbore. A hydrocarbon-producing wellbore is formed by utilizing a drill string and drill bit to bore into a subterranean formation while circulating drilling fluid. The drilling fluid, also referred to as drilling mud in the industry, among other things, lubricates and cools the drill bit as it bores into the formation; entrains small pieces of rock that break away from the formation, referred to as cuttings, and returns them to the surface; and balances formation pressure.

After a wellbore is drilled, casing is placed therein and may be strengthened by the formation of a cement sheath. In certain instances, a cement sheath is thereafter formed by pumping a cement fluid, also referred to as a cement slurry in the industry, through the interior of the casing and up through the annulus between the exterior of the casing and the formation. The cement fluid thereafter cures in the annulus, thereby forming the cement sheath.

In certain circumstances, during drilling operations and/or cementing operations, a portion of the respective fluid may be lost to the formation. This loss, referred to as “lost circulation,” may occur due to natural causes, such as conductive fractures, vugs, or high permeability zones, or by induced fractures caused by high annular circulation pressures (equivalent circulating densities). Lost circulation during drilling and/or cementing operations not only results in costly loss of expensive fluids, but may interfere with drilling and completion efficiency and pressure balance, and may even result in loss of well control and require well abandonment.

To combat lost circulation, a lost circulation material may be provided within the drilling and/or cementing fluid to restrict and/or prevent fluid flow through seepage pathways. These lost circulation materials must have appropriate density, size, structural integrity, and compatibility with the carrier fluid to which they are added.

### SUMMARY OF THE INVENTION

This application relates to wellbore drilling and/or cementing operations, and, in particular, to lost circulation material formed from petroleum coke, and methods related thereto.

In nonlimiting aspects of the present disclosure, a lost circulation fluid is provided. The lost circulation fluid includes a carrier fluid; and lost circulation particles composed one or both of fluid coke and/or flexicoke, the lost circulation particles having a particle density of equal to or less than about 1.6 g/cc.

In nonlimiting aspects of the present disclosure, a method of introducing a lost circulation fluid into a subterranean formation, the lost circulation fluid comprising a carrier fluid and lost circulation particles composed one or both of fluid coke and/or flexicoke, the lost circulation particles having a particle density of equal to or less than about 1.6 g/cc.

These and other features and attributes of the disclosed petroleum coke lost circulation material of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1A illustrates a particle size distribution chart of samples of fluid coke lost circulation particles for use in one or more aspects of the present disclosure.

FIG. 1B illustrates a particle size distribution chart of samples of flexicoke lost circulation particles for use in one or more aspects of the present disclosure.

FIG. 2 illustrates a size chart of the size of the tested fluid coke and flexicoke lost circulation particle samples both before and after conducting crush testing for use in one or more aspects of the present disclosure.

### DETAILED DESCRIPTION OF THE INVENTION

This application relates to wellbore drilling and/or cementing operations, and, in particular, to lost circulation material formed from petroleum coke, and methods related thereto.

It is to be understood that while the present disclosure refers primarily to drilling fluids having the petroleum coke lost circulation materials of the present disclosure, the use of petroleum coke lost circulation materials in a cementing fluid is equally applicable to the disclosure provided herein, without limitation.

As discussed above, control of fluid loss may be facilitated by the use of a lost circulation material. However, oftentimes there are difficulties encountered during lost circulation treatments during drilling and/or cementing activities. Indeed, drilling fluid, for example is carefully designed to maintain a density within a “safe drilling window”—in which the density of the drilling fluid is high enough to create a hydraulic pressure at the drill bit that is higher than the pore pressure of the subterranean formation being drilled to prevent an influx of fluid into the well (referred to as a “kick”) but not so high as to cause the rock to fracture, thereby resulting in a loss of drilling fluid and potentially loss in well control. Often the safe drilling window is quite a narrow density and a lost circulation material can cause a density alteration to the drilling fluid. Accordingly, a lost circulation material having a density that is the same or substantially the same as the density of the drilling fluid can afford greater density control and thus more effective drilling and/or cementing of a wellbore. Moreover, lost circulation materials require adequate suspension and transport within a drilling (or a cementing) fluid to permit formation of a wellbore having desired fluid permeability and conductivity.

Traditional lost circulation materials include relatively high density materials such as calcium carbonates, crushed mica, cellulosic plant particles, graphite, dolomites, gilsonite, ground asphaltene or even organic materials such as kenaf, walnut hulls, peanut hulls, coconut coir, and the like. These high density lost circulation materials often result in transport difficulties, requiring particularly high density drilling and/or viscosity fluids (i.e., high polymer or bentonite clay viscosifier loading) and thus necessitating relatively low fluid flow (pump) rates, which can lead to density alterations or other complications.

The present disclosure alleviates the foregoing difficulties and provides related advantages as well. In particular, the present disclosure provides a low density lost circulation material composed of petroleum coke, and, particularly, fluid coke and/or flexicoke. The low density petroleum coke lost circulation materials described herein can be effectively suspended in a fluid and delivered at a high flow rate into a wellbore for drilling and/or cementing and also exhibit high crush strengths (similar to sand), thereby addressing shortcomings of traditional lost circulation materials. It is to be understood that the term “petroleum coke,” as used herein, refers to both fluid coke and flexicoke, unless otherwise stated for ease of description. Accordingly, the “petroleum coke” of the present disclosure is distinguished from delayed coke and other types of coke that have very different properties and are not considered suitable for use as a lost circulation material, as described hereinbelow.

By using fluid coke and/or flexicoke as lost circulation material, CO₂ emissions are reduced as the coke can otherwise be used as a fuel source. In effect, using the petroleum coke lost circulation material described herein is a form of sequestering carbon that would otherwise contribute to CO₂ emissions.

Fluid coking is a carbon rejection process that is used for upgrading heavy hydrocarbon feeds and/or feeds that are challenging to process. The process produces a variety of lighter, more valuable liquid hydrocarbon products, as well as a substantial amount of fluid coke as byproduct.

The fluid coke byproduct comprises high carbon content and various impurities. The fluid coking process may be manipulated to obtain fluid coke having the distinctive characteristics described herein that are suitable for use as lost circulation material, including as a supplement or replacement to traditional lost circulation material.

Flexicoke is produced from a modified variation of fluid coking, termed FLEXICOKING™ (trademark of ExxonMobil Research and Engineering Company (“ExxonMobil”)). FLEXICOKING™ is based on fluidized bed technology developed by ExxonMobil, and is a carbon rejection process that is used for upgrading heavy hydrocarbon feeds (referred to as “residua”). Unlike fluid coking, which utilizes a reactor and a burner, the FLEXICOKING™ process uses a reactor, a heater, and a gasifier. The FLEXICOKING™ process is described in greater detail below.

Illustrative petroleum coke (including either or both of fluid coke or flexicoke) lost circulation particles of the present disclosure may have, among other characteristics, a particle density of less than about 1.6 g/cc, and are suitable for inclusion in a carrier fluid for lost circulation during a drilling and/or cementing operation within a horizontal, vertical, or tortuous wellbore, including hydrocarbon-bearing production wellbores and water-bearing production wellbores.

### Definitions and Test Methods

As used herein, the term “lost circulation,” and grammatical variants thereof, refers to an uncontrolled flow of drilling mud and/or cementing mud into a subterranean formation during a drilling and/or cementing operation, respectively. As used herein, the term “lost circulation material,” and grammatical variants thereof, refers to a collection of lost circulation particles designed to reduce or prevent the flow of fluids into the formation. Thus, a “lost circulation operation,” and grammatical variants thereof, refers to the use of a lost circulation material during a drilling and/or cementing operation to control lost circulation, the wellbore being drilled and/or cemented may thus be an open hole or cased wellbore. Lost circulation materials have traditionally been fibrous or plate-like in shape and require sufficient strength (e.g., crush strength) to avoid breaking into smaller particles.

As used herein, the term “carrier fluid,” and grammatical variants thereof, refers to a fluid used to transport a lost circulation material into a wellbore, which may include various additives, without departing from the scope of the present disclosure, and as would be apparent by one of ordinary skill in the art in light of the present disclosure. The “carrier fluid” of the present disclosure thus may be suitable for drilling operations and/or cementing operations (having at least cement as an additive), depending on the nature of the operation being performed.

As used herein, the term “petroleum coke,” and grammatical variants thereof, refers to fluid coke or flexicoke, and is used herein to represent both unless otherwise indicated. The petroleum coke described herein is used as a low density lost circulation material for lost circulation control during a drilling and/or cementing operation. The term “petroleum coke lost circulation material” refers to lost circulation material composed of fluid coke or flexicoke, and is used interchangeably with the term “petroleum coke lost circulation particles.”

As used herein, the term “fluid coke,” and grammatical variants thereof, refers to the solid concentrated carbon material remaining from fluid coking. The term “fluid coking” refers to a thermal cracking process utilizing fluidized solids for the conversion of heavy, low -grade hydrocarbon feeds into lighter products (e.g., upgraded hydrocarbons), producing fluid coke as a byproduct. The term “fluid coke lost circulation material” refers to lost circulation material composed of fluid coke, and is used interchangeably with the term “fluid coke lost circulation particles.”

The fluid coke lost circulation material described herein may have a carbon content of 75 weight percent (wt %) to 93 wt %, or 78 wt % to 90 wt %; a weight ratio of carbon to hydrogen of 30:1 to 50:1, or 35:1 to 45:1; an impurities content (weight percent of all components other than carbon and hydrogen) of 5 wt % to 25 wt %, or 10 wt % to 20 wt %; a sulfur content of 3 wt % to 10 wt %, or 4 wt % to 7 wt %; and a nitrogen content of 0.5 wt % to 3 wt %, or 1 wt % to 2 wt %, each encompassing any value and subset therebetween.

As used herein, the term “flexicoke” refers to the solid concentrated carbon material produced from FLEXICOKING™. The term “FLEXICOKING™” refers to a thermal cracking process utilizing fluidized solids and gasification for the conversion of heavy, low-grade hydrocarbon feeds into lighter hydrocarbon products (e.g., upgraded, more valuable hydrocarbons). The term “flexicoke lost circulation material” refers to lost circulation material composed of flexicoke (i.e., partially gasified fluid coke), and is used interchangeably with the term “flexicoke lost circulation particles.”

Briefly, the FLEXICOKING™ process in which the flexicoke for forming the flexicoke lost circulation material described herein, integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically about 496° C. to about 538° C. A return stream of coke sent from the gasifier to the heater provides the remainder of the heat requirement. The coke meeting the heat requirement is then circulated to the reactor and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor—the resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

The flexicoke lost circulation material described herein may have a carbon content of 85 wt % to 99 wt %, or 90 wt % to 96 wt %; a weight ratio of carbon to hydrogen of 80:1 to 98:1, or 85:1 to 95:1; an impurities content (weight percent of all components other than carbon and hydrogen) of 1 wt % to 15 wt %, or 3 wt % to 10 wt %; a combined vanadium and nickel content of 3000 ppm to 45,000 ppm, or 3000 ppm to 15,000 ppm, or 5000 ppm to 30,000 ppm, or 30,000 ppm to 45,000 ppm; a sulfur content of 0 wt % to 5 wt %, or 0.5 wt % to 4 wt %; and a nitrogen content of 0 wt % to 3 wt %, or 0.1 wt % to 2 wt %, each encompassing any value and subset therebetween.

As used herein, the term “particle density,” and grammatical variants thereof, with reference to the density of lost circulation particles, refers to the density of the individual particles themselves, which may be expressed in grams per cubic centimeter (g/cc). The particle density values of the present disclosure are based on the American Petroleum Institute's Recommended Practice 19C standard entitled “Measurement of Properties of Proppants Used in Hydraulic Fracturing and Gravel-packing Operations” (Second Ed., September 2020) (hereinafter “API RP-19C” of the same edition).

As used herein, the terms D10, D50, and D90 are used to describe particle sizes. As used herein, the term “D10” refers to a diameter at which 10% of the sample (on a volume basis unless otherwise specified) is comprised of particles having a diameter less than said diameter value. As used herein, the term “D50” refers to a diameter at which 50% of the sample (on a volume basis unless otherwise specified) is comprised of particles having a diameter less than said diameter value. As used herein, the term “D90” refers to a diameter at which 90% of the sample (on a volume basis unless otherwise specified) is comprised of particles having a diameter less than said diameter value. Particle size can be determined by light scattering techniques or analysis of optical digital micrographs. Unless otherwise specified, laser particle size analysis is used for analyzing particle size.

As used herein, the term “crush strength,” with reference to lost circulation particles, refers to the stress load that the lost circulation particles can withstand prior to crushing (e.g., breaking or cracking). The crush strength values of the present disclosure are based on API RP-19C.

All numerical values within the detailed description and the claims herein are modified by “about” or “approximately” with respect to the indicated value, and take into account experimental error and variations that would be expected by a person having ordinary skill in the art.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

Petroleum Coke Lost circulation Material, Methods and Systems

Drilling and/or cementing operations require effective control of fluid loss using lost circulation materials that remain in suspension and are strong enough to withstand stresses introduced by such operations. Accordingly, effective lost circulation materials are typically associated with a variety of characteristics or properties, including efficient transport within a carrier fluid and sufficient mechanical strength.

According to Stokes' law, the rate of settling of a particle of lost circulation material within a carrier fluid is directly proportional to the difference in density between the particle and the fluid. Thus, a lost circulation particle having a density that is closer to that of the carrier fluid is more likely to remain in suspension compared to a lost circulation particle having density is much higher than that of the carrier fluid. Moreover, as will be appreciated, the petroleum coke lost circulation material of the present disclosure having lower particle densities settle at a slower rate within an identical carrier fluid (thus having better transport) compared to higher particle density particle sized lost circulation particles.

The particle density of the petroleum coke lost circulation material of the present disclosure is equal to or less than about 1.6 grams per cubic centimeter (g/cc), including in the range of 1.4 g/cc to 1.6 g/cc, or 1.5 g/cc to 1.6 g/cc, encompassing any value and subset therebetween. As provided above, traditional lost circulation particles generally have particle densities greater than about 2.0 g/cc. Thus, the petroleum coke lost circulation particles described herein have substantially lesser particle densities compared to traditional lost circulation particles, which is indicative of their comparably more effective transport and lower settling rates within a carrier fluid used as part of a drilling and/or cementing operation. Moreover, as described in greater detail below, the density of the carrier fluids for use in the embodiments of the present disclosure may be in the range of 1.0 g/cc to 1.5 g/cc, or 1.0 g/cc to 1.2 g/cc, encompassing any value and subset therebetween. Accordingly, the petroleum coke lost circulation particles also have a density closer to the desired carrier fluid compared to traditional lost circulation particles and will, as per Stokes' law, exhibit better suspension for this reason, as well.

Further, as described hereinabove, the low density of the petroleum coke lost circulation particles permits a reduction in viscosifier (e.g., polymer or bentonite clay) load in the carrier fluid, thereby reducing costs of the drilling and/or cementing operations and also permitting a reduction in pump rates compared to traditional drilling and/or cementing operations. As such, pump requirements can be comparably more flexible and fracturing of the formation can be better or completely avoided. Moreover, selection of a petroleum coke lost circulation material having buoyancy similar or same density compared to the carrier fluid can further enhance pumping flexibility, better ensuring that the particles will remain in suspension rather than settling to a heel of the wellbore.

A lost circulation particle's crush strength is a measure of its ability to withstand compressive stresses within a formation (e.g., as the particles are pressurized by drilling pumps and circulation down drill pipe and through drill bit nozzles). Lost circulation particles that are not able to withstand the imposed stresses within a formation during drilling and/or cementing will crush, resulting in the formation of “fines” that reduce or prevent the lost circulation material from properly functioning. Accordingly, lost circulation particles with higher crush strengths are favorable. According to API RP-19C standards, adequate lost circulation particles should have a crush strength in which a minimum number of fines are produced under a stress of 2000 psi, depending on the size of the lost circulation particles.

The particular crush strength of lost circulation particles may depend on a number of factors including, but not limited to, the overpressure gradient, the depth of the wellbore, the integrity of the subterranean formation (e.g., conventional or unconventional formation), and the like, and any combination thereof. The crush strength of lost circulation particles may further be at least partially dependent upon the size of the individual particles. Traditional lost circulation particles have particle diameters in the range of about 50 micrometers (μm) to 2500 μm. The petroleum coke lost circulation particles described herein are comparable in particle diameter size having a D50 of 50 μm to 500 μm, or 100 μm to 400 μm, or 150 μm to 350 μm, encompassing any value and subset therebetween.

In some aspects, the crush strength of the petroleum coke lost circulation particles described herein may be in the range of 3000 pounds per square inch (psi) to 12,000 psi, or 3000 psi to 6000 psi, or 5000 psi to 10,000 psi, or 7500 psi to 12,000 psi, encompassing any value and subset therebetween. In some instances, a size in the range of 300 to 600 μm may be particularly effective for lost circulation purposes, encompassing any value and subset therebetween.

The Krumbein Chart provides an analytical tool to standardize visual assessment of the sphericity and roundness of particles, including lost circulation particles. Each of sphericity and roundness is visually assessed on a scale of 0 to 1, with higher values of sphericity corresponding to a more spherical particle and higher values of roundness corresponding to less angular contours on a particle's surface. According to API RP-19C standards, the shape of a lost circulation particle is considered adequate for use in drilling and/or cementing operations if the Krumbein value for both sphericity and roundness is ≥0.6. The sphericity of the petroleum coke lost circulation particles of the present disclosure are in the range of 0.6 to 1.0, encompassing any value and subset therebetween. The roundness of the petroleum coke lost circulation particles of the present disclosure are in the range of 0.6 to 1.0, encompassing any value and subset therebetween.

The petroleum coke lost circulation material having the characteristics described herein exhibit the aforementioned properties, as well as others, which make them not only a viable alternative for traditional lost circulation material, but further a surprising substitute with enhanced functionality. Moreover, the petroleum coke lost circulation material, although derived from refinery operations, exhibit only minimal metal leaching in a wellbore environment and are compatible with various carrier fluids and additives, as described herein below.

The petroleum coke lost circulation material described herein may be used as part of a lost circulation fluid for use in a drilling and/or cementing operation, the lost circulation fluid comprising a flowable (e.g., liquid or gelled) carrier fluid and one or more optional additives. This lost circulation fluid can be formulated at the well site in a mixing process that is conducted while it is being pumped into a forming or otherwise drilled wellbore. When the lost circulation fluid is formulated at the well site, petroleum coke lost circulation material can be added in a manner similar to the known methods for adding traditional lost circulation material into a drilling and/or cementing fluid. In various aspects, the fluid coke and/or flexicoke material received from a respective coking process are first processed (e.g., at the manufacturing facility, which may be at or near the well site) to remove any undesirably sized material that has adhered or otherwise conglomerated prior to use as the petroleum lost circulation particles described herein. Optionally, the removal process can be skipped, conducted at another facility, or performed in the field. In other or additional aspects, any fines may be preferably removed from the petroleum coke lost circulation material, such as by use of bag filters or sieves, whether in storage or during transport.

As such, a more uniform or narrow size distribution may be obtained. In addition to the petroleum coke lost circulation material, it is within the scope of the present disclosure that such petroleum coke lost circulation material be included alone or in combination with one or more other traditional types of lost circulation particles. When petroleum coke lost circulation material is included in combination with another type of lost circulation material, the various particles can be mixed as a dry solid, mixed in a slurry, or added separately into a lost circulation fluid that is being formulated at the well site.

The carrier fluid of the present disclosure may be comprised of an aqueous-based fluid, a nonaqueous-based fluid, or a synthetic-based fluid, Aqueous-based fluids may include, but are not limited to, fresh water, saltwater (including seawater), treated water (e.g., treated production water), other forms of aqueous fluid, and any combination thereof. Nonaqueous-based fluids may include, for example, oil-based fluids (e.g., hydrocarbon, olefin, mineral oil), alcohol-based fluids (e.g., methanol), and any combination thereof.

In various aspects, the viscosity and density of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers. It is to be noted, however, that because the petroleum coke lost circulation particles of the present disclosure exhibit particularly low density, the carrier fluid can be void of foaming or gelling agents or may otherwise comprise a reduced amount of foaming or gelling agents compared to a carrier fluid comprising traditional lost circulation particles.

In addition, the carrier fluids may comprise one or more additives such as, for example, cement, dilute aids, biocides, breakers, corrosion inhibitors, crosslinkers, friction reducers (e.g., polyacrylamides), gelling agents (e.g., hydroxypropyl guar), salts (e.g., KCl), oxygen scavengers, pH control additives, scale inhibitors, surfactants, weighting agents, inert solids, fluid loss control agents, emulsifiers, emulsion thinners, emulsion thickeners, viscosifying agents, particles, foaming agents (e.g., air or other gases, such as CO₂, N₂, and the like), buffers, stabilizers, chelating agents, mutual solvents, oxidizers, reducers, clay stabilizing agents, and any combination thereof.

Generally, the petroleum coke lost circulation material loading within a carrier fluid is in the range of about 3 pounds per barrel (lb/bbl) to about 100 lb/bbl (equivalent to about 8.56 kilograms per cubic meter (kg/m³) to about 285.3 kg/m³), encompassing any value and subset between.

The methods described herein include preparation of lost circulation fluid (comprising a carrier base fluid), which is not considered to be particularly limited, because the petroleum coke lost circulation material of the present disclosure are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the petroleum coke lost circulation material may be added to a carrier fluid, including optional additives, at a production site, either directly into a wellbore or by pre-mixing in a hopper or other mixing equipment.

The methods of drilling and/or cementing operations suitable for use in one or more aspects of the present disclosure comprising the use of petroleum lost circulation material involve high pump rates in relatively low viscosity carrier fluids into a formation as it is being drilled (drilling operation), or into a wellbore within the formation between casing and the surface of the a drilled wellbore (cementing operation). More particularly, the methods described herein include drilling a wellbore in a subterranean formation and/or installing a cement sheath within a wellbore. The subterranean formation may be a conventional or unconventional substrate and the wellbore may be vertical, horizontal, or otherwise deviated or tortuous, hydrocarbon-producing (e.g., oil and/or gas) wellbores and water-producing wellbores. These wellbores may be in various subterranean formation types including, but not limited to, shale formations, oil sands, gas sands, and the like.

A drilling operation is performed by circulating drilling fluid comprising the petroleum coke lost circulation materials of the present disclosure through a drill string and drill bit. The drill bit crushes or cuts the subterranean formation rock and the cuttings, along with the drilling fluid, is circulated to the surface. A cementing operation is performed by inserting casing string within the wellbore and pumping a cement fluid comprising the petroleum coke lost circulation materials of the present disclosure through the casing and up through the annulus between the exterior of the casing string and the surface of the drilled wellbore, where it is allowed to harden and set.

### Exemplary Embodiments:

Nonlimiting example embodiments of the present disclosure include:

Embodiment A: A lost circulation fluid comprising: a carrier fluid; and lost circulation particles composed one or both of fluid coke and/or flexicoke, the lost circulation particles having a particle density of less than about 1.6 g/cc.

Embodiment B: A method comprising: introducing a lost circulation fluid into a subterranean formation, the lost circulation fluid comprising a carrier fluid and lost circulation particles composed one or both of fluid coke and/or flexicoke, the lost circulation particles having a density of less than about 1.6 g/cc.

Nonlimiting example Embodiments A or B may include one or more of the following elements:

Element 1: Wherein the lost circulation particles are composed of fluid coke.

Element 2: Wherein the lost circulation particles are composed of flexicoke.

Element 3: Wherein the lost circulation particles have a particle density in the range of about 1.4 g/cc to about 1.6 g/cc.

Element 4: Wherein the lost circulation particles have a crush strength of about 3000 psi to about 12000 psi.

Element 5: Wherein the lost circulation particles have an average particle size distribution in the range of about 50 μm to about 2500 μm.

Element 6: Wherein the lost circulation particles have a Krumbein sphericity value of ≥0.6.

Element 7: Wherein the lost circulation particles have a Krumbein roundness value of ≥0.6.

Element 8: Further comprising second lost circulation particles composed of a material that is not fluid coke or flexicoke.

Element 9: Further comprising a cement additive.

Embodiments A or B may be in any combination with one, more, or all of Elements 1 through 9, including 1 and 2, 1 and 3, 1 and 4, 1 and 5, 1 and 6, 1 and 7, 1 and 8, 1 and 9, 2 and 3, 2 and 4, 2 and 5, 2 and 6, 2 and 7, 2 and 8, 2 and 9, 3 and 4, 3 and 5, 3 and 6, 3 and 7, 3 and 8, 3 and 9, 4 and 5, 4 and 6, 4 and 7, 4 and 8, 4 and 9, 5 and 6, 5 and 7, 5 and 8, 5 and 9, 6 and 7, 6 and 8, 6 and 9, 7 and 8, 7 and 9, 8 and 9, and any other nonlimiting combinations of 1 through 9.

Nonlimiting example Embodiment B may include one or more of the following elements:

Element 10: Further comprising: circulating the lost circulation fluid while drilling a wellbore through the subterranean formation.

Element 11: Further comprising: wherein the lost circulation fluid further comprises a cement additive and, further comprising: emplacing a cement sheath within a wellbore drilled through the subterranean formation.

Element 12: Further comprising: sequestering carbon in the subterranean formation in the form of the lost circulation particles.

Embodiment B may be in any combination with one, more, or all of Elements 10 and 11, 10 and 12, 11 and 12, and any other nonlimiting combination of Elements 10 through 12.

Unless otherwise indicated, all numbers expressing quantities of ingredients, properties such as molecular weight, reaction conditions, and so forth used in the present specification and associated claims are to be understood as being modified in all instances by the term “about,” and take into account experimental error and variations that would be expected by a person having ordinary skill in the art. Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the aspects of the present disclosure, the following examples of preferred or representative aspects are given. In no way should the following examples be read to limit, or to define, the scope of the disclosure.

### EXAMPLES

In the following examples, properties of petroleum coke lost circulation material of the present disclosure are evaluated. Fluid coke :lost circulation material was obtained from the Imperial Oil Refinery located in Sarnia, Ontario, Canada or the Syncrude Canada Refinery located Calgary, Canada; flexicoke lost circulation material was obtained from the ExxonMobil Refinery located in Baytown, Tex.

### Size

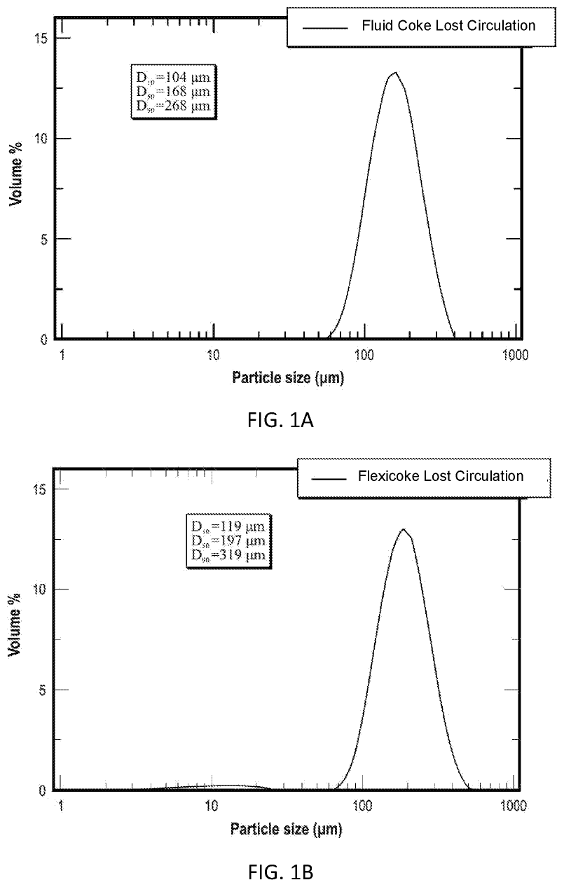

The petroleum coke lost circulation material of the present disclosure was characterized by particle size using laser particle size analysis. The particle size distribution of fluid coke lost circulation particles is shown in FIG. 1A; and the particle size distribution of flexicoke lost circulation particles is shown in FIG. 1B.

As shown in FIG. 1A, about 85% of the fluid coke lost circulation particles by weight were within a particle size range of about 74 μm to about 425 μm. The average particle size (D₅₀) of the fluid coke lost circulation particles was 168 μm; the D₁₀ value was 104 μm; and the D₉₀ value was 268 μm.

As shown in FIG. 1B, about 82% of the flexicoke lost circulation particles by weight were within a particle size range of about 74 μm to about 425 μm. The average particle size (D₅₀) of the flexicoke lost circulation particles was 197 μm; the D₁₀ value was 119 μm; and the D₉₀ value was 319 μm. Sieving

Two (2) experimental samples (EX1 (source 1), EX2 (source 2)) of fluid coke lost circulation material and one (1) experimental sample (EX3) of flexicoke were sieved to obtain an average size of 100 mesh (149 μm). The various experimental samples were compared to control samples of sand particles (CL), each also having an average particle size of 100 mesh (149 μm). It is noted that sand is not typically used in lost circulation applications, but was used as a comparison for strength and density, as sand is known to have high compressive strength and structural integrity.

These samples were tested as described hereinbelow; it is to be noted that not all experiments involve all of the experimental sample types.

### Density

EX1 was tested in duplicate for density using API PR-19C for particle density. The results are shown in Table 1 below.

TABLE 1

| Sample | Particle density (g/cc) |
|---|---|
| EX1 (duplicate 1) | 1.4-1.6 |
| EX1 (duplicate 2) | 1.4-1.6 |
| CL | 2.65 |

As shown in Table 1, the values for the particle densities of the petroleum coke lost circulation particle samples exhibit a substantially lower particle densities compared to CL sample.

### Crush Strength

The samples were subject to increasing stress loads and the stress level, in pounds per square inch (psi), at which 10% of each sample was crushed to a size below the smallest initial sieve. The results are shown in Table 2 below.

TABLE 2

| Sample | Crush Strength (psi) |
|---|---|
| EX1 | 11,000 |
| EX2 | 9,000 |
| EX3 | 9,000 |
| CL (duplicate 1) | 10,000 |
| CL2 (duplicate 2) | 8,000 |

As shown in Table 2, the fluid coke (EX1, EX2) and flexicoke (EX3) lost circulation material samples exhibited improved or comparable crush strengths compared to the CL samples. This result indicates that the lighter density petroleum coke lost circulation particles of the present disclosure can adequately form withstand crush strengths comparable to sand particles. Further, this illustrates that the petroleum coke lost circulation particles of the present disclosure resist the formation of fines that would reduce interference with lost circulation control effectiveness.

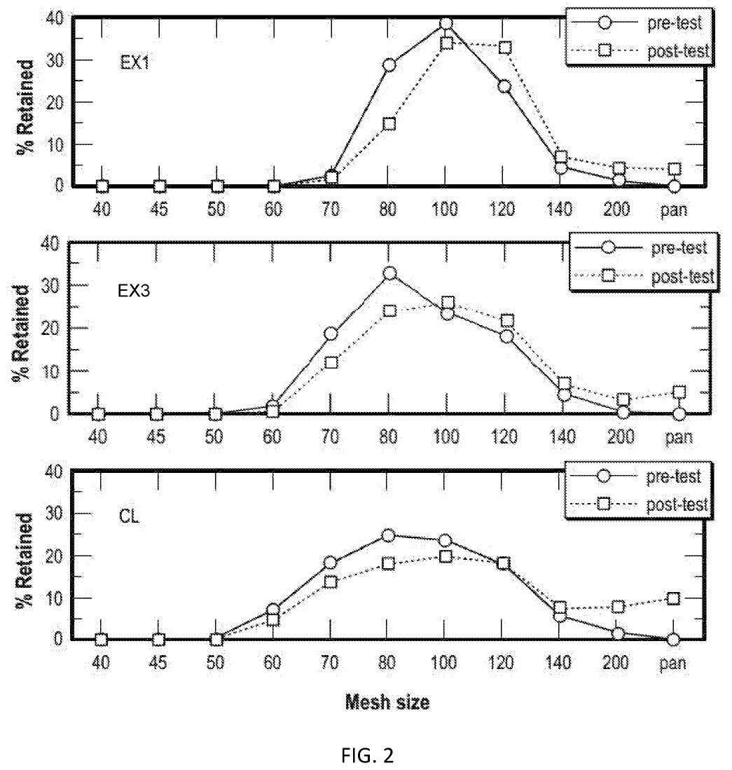

Prior to, and after, the crush testing, the particle size distribution of the EX1, EX3 and CL samples were evaluated for comparison. The results are shown in FIG. 2. Each of the EX1, EX3, and CL samples experienced a shift in particle sieve size distribution toward smaller mesh sizes after testing, but a larger fraction of the CL sample was finer in size (labeled “pan”) compared to the EX1 and EX3 samples at the end of testing. Without being bound by theory, it is believed that this result is associated with an increased ductility of the fluid coke and flexicoke lost circulation material compared to traditional sand. That is, the sand particles may be more influenced by deformation and consolidation because sand is more brittle compared to fluid coke and flexicoke, it will maintain its shape at certain stress levels, but begins to fail as stress levels increase.

### Fluid Compatibility

Sample EX1 was tested for fluid compatibility (dissolution or degradation) in an oil environment. In particular, an oil soak test was performed over an 8 week period. Approximately 5 grams of EX1 lost circulation material was placed in 500 milliliters of Permian Basin oil at elevated temperature (180° F. (equivalent to 82.2° C.)) and under pressure (6000 psi). The petroleum coke lost circulation materials were decanted after 2 weeks, 4 weeks, and 8 weeks and compression tested in an uniaxial load frame set to 5000 psi and under increasing temperature from 70° F. (equivalent to 21.1° C.) to 190° F. (equivalent to 87.8° C.) to simulate reservoir temperature.

Identical testing was performed on a control (CL) sand sample.

There was no significant reduction in strength over the 8 week testing period for the EX1 or the CL lost circulation material. The strain that was observed when under a constant compressive stress of 5000 psi did not change significantly (±5%) either when changing the length of time of oil soaking (up to 8 weeks) or the temperature being tested (up to 190° F.). Further, visual observation of the tested materials did not reveal any significant reduction in particle size, further supporting the conclusion that the petroleum coke lost circulation materials described herein are not experiencing dissolution in an oil environment. Leaching

Sample EX1 was tested for metal leaching in aqueous based carrier fluids. 0.1 grams of EX1 lost circulation material was placed in 100 milliliters of deionized (DI) water and continuously stirred at room temperature for 24 hours. The results were tested for sulfur, strontium, and vanadium. EX1 had a concentration of about 8 parts per billion (ppb) of sulfur compared to about 4 ppb of a DI water control. Further EX1 exhibited minimal strontium of about 1 ppb and minimal vanadium of about 2.5 ppb. Again, this illustrates the suitability of the petroleum coke lost circulation material of the present disclosure for use in drilling and/or cementing operations.

Accordingly, the fluid coke and flexicoke lost circulation material of the present disclosure are suitable for use in drilling and/or cementing operations, including in unconventional formation types.

Further leaching testing was carried out on sample EX1. In subsequent testing, 50 g of EX1 was placed in 50 milliliters of 3 different Texas regional produced water samples and continuously stirred at 180° F. (˜82° C.) for up to 7 days. The results were tested for sulphates, strontium, and vanadium. The sulphate concentrations in the three produced water samples after being stirred with EX1 did not vary more than 5% from the original sulphate concentration (this is within the accuracy of the ICP testing that was carried out). The produced water after being stirred with EX1 also exhibited minimal changes in strontium (˜10%) and minimal vanadium (<11ppm); there was no vanadium in the produced water samples prior to mixing with EX1. Again, this illustrates the suitability of the petroleum coke lost circulation material of the present disclosure for use in drilling and/or cementing operations.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A lost circulation fluid comprising:
a carrier fluid; and
lost circulation particles composed one or both of fluid coke and/or flexicoke, the lost circulation particles having a particle density of equal to or less than about 1.6 g/cc.

2. The lost circulation fluid of claim 1, wherein the lost circulation particles are composed of fluid coke.

3. The lost circulation fluid of claim 1, wherein the lost circulation particles are composed of flexicoke.

4. The lost circulation fluid of claim 1, wherein the lost circulation particles have a particle density in the range of about 1.4 g/cc to about 1.6 g/cc.

5. The lost circulation fluid of claim 1, wherein the lost circulation particles have a crush strength of about 3000 psi to about 12000 psi.

6. The lost circulation fluid of claim 1, wherein the lost circulation particles have an average particle size distribution in the range of about 50 μm to about 2500 μm.

7. The lost circulation fluid of claim 1, wherein the lost circulation particles have a Krumbein sphericity of ≥0.6.

8. The lost circulation fluid of claim 1, wherein the lost circulation particles have a Krumbein roundness value of ≥0.6.

9. The lost circulation fluid of claim 1, further comprising second lost circulation particles composed of a material that is not fluid coke or flexicoke.

10. The lost circulation fluid of claim 1, further comprising a cement additive.

11. A method comprising:
introducing a lost circulation fluid into a subterranean formation, the lost circulation fluid comprising a carrier fluid and lost circulation particles composed one or both of fluid coke and/or flexicoke, the lost circulation particles having a particle density of equal to or less than about 1.6 g/cc.

12. The method of claim 11, further comprising:
circulating the lost circulation fluid while drilling a wellbore through the subterranean formation.

13. The method of claim 11, wherein the lost circulation fluid further comprises a cement additive and, further comprising:
emplacing a cement sheath within a wellbore drilled through the subterranean formation.

14. The method of claim 11, further comprising:
sequestering carbon in the subterranean formation in the form of the lost circulation particles.

15. The method of claim 11, wherein the lost circulation particles are composed of fluid coke.

16. The method of claim 11, wherein the lost circulation particles are composed of flexicoke.

17. The method of claim 11, wherein the lost circulation particles have a particle density in the range of about 1.4 g/cc to about 1.6 g/cc.

18. The method of claim 11, wherein the lost circulation particles have a crush strength of about 3000 psi to about 12000 psi.

19. The method of claim 11, wherein the lost circulation particles have an average particle size distribution in the range of about 50 μm to about 2500 μm.

20. The method of claim 11, wherein the lost circulation fluid further comprises second lost circulation particles composed of a material that is not fluid coke or flexicoke.
